(19) United States
(12) Patent Application Publication
(10) Pub. No.: US 2019/0303770 A1
(43) Pub. Date: Oct. 3, 2019

(54) ARCHITECTURAL COMPOSITE SERVICE SOLUTION BUILDER

(71) Applicant: International Business Machines Corporation, Armonk, NY (US)

(72) Inventors: Enrico Vannini, Rome (IT); Robert Barron, Tel Aviv (IL); William L. Yates, Portsmouth (GB); Christopher Phillips, Woolston (GB)

(21) Appl. No.: 15/938,148

(22) Filed: Mar. 28, 2018

(51) Int. Cl. G06N 5/02; G06F 17/30; G06N 99/00

(52) U.S. Cl. CPC G06N 5/022; G06N 99/005; G06F 17/30873

(57) ABSTRACT

Using machine-controlled web navigation and machine learning, each of a composite knowledge base of service components and a composite service catalog are created. The composite knowledge base is defined by features that are offered, and how the respective service component connects and exchanges data with other service components. The composite service catalog includes identified available implementations of the service components. Using machine-based application of machine-learned knowledge created within the composite knowledge base and the composite service catalog, the service component definitions are applied to a service solution under development to identify at least one service component usable to provide a technological improvement of the service solution under development. A service technology improvement report is outputted that details the technological improvement of the service solution under development provided by the identified at least one service component.

### BACKGROUND

The present invention relates to integration of components into functional solutions. More particularly, the present invention relates to an architectural composite service solution builder.

Distributed web sites and cloud computing platforms may host usable software service-oriented products. These software service-oriented products represent stand-alone tools that are provided by the different respective platforms.

### SUMMARY

A computer-implemented method includes, by a processor: creating, by machine-controlled web navigation and machine learning, each of: (1) a composite knowledge base of service components, with each service component in the composite knowledge base defined by (i) features that are offered, and (ii) how the respective service component connects and exchanges data with other service components; and (2) a composite service catalog including identified available implementations of the service components; applying, by machine-based application of machine-learned knowledge created within the composite knowledge base and the composite service catalog, the service component definitions to a service solution under development to identify at least one service component usable to provide a technological improvement of the service solution under development; and outputting a service technology improvement report that details the technological improvement of the service solution under development provided by the identified at least one service component.

A system that performs the computer-implemented method and a computer program product that causes a computer to perform the computer-implemented method are also described.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 is a block diagram of an example of an implementation of an alternative system for implementation of an architectural composite service solution builder according to an embodiment of the present subject matter;

FIG. 4 is a block diagram of an example of an implementation of a core processing module capable of operating as an architectural composite service solution builder according to an embodiment of the present subject matter;

FIG. 5 is a flow chart of an example of an implementation of a process for an architectural composite service solution builder according to an embodiment of the present subject matter; and

FIG. 6 is a flow chart of an example of an implementation of a process for an architectural composite service solution builder that provides additional technical details of each of the machine learning processing and the machine-based application of knowledge processing according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides an architectural composite service solution builder. The architectural composite service solution builder is alternatively termed and considered a real-time architectural composite service solution builder because the described computing platform operates in real-time as defined herein to expedite identification of improved composite service solutions. The present technology solves several recognized problems associated with conventional architecting of service solutions from conventional web-sourced software service-oriented products and components, such as platform as a service (PaaS) architectural environments and/or software as a service (SaaS) environments. The technology described herein provides new computing technology that includes a new form of a software service-oriented product and component analyzer computing platform that independently provides computational processing within complex Internet-based computing environments. This new technology applies machine learning to navigate the Internet to autonomously identify and evaluate software service-oriented product and component offerings (e.g., usable “tools”) across multiple web-based environments and hosting domains to arrive at two (2) new electronic system/systematically-gathered compendiums: (i) a composite knowledge base; and (ii) a composite service catalog. These two compendiums are collectively termed “knowledge bases” or “composite knowledge bases” for brevity of reference herein when discussed together. As will be described in more detail below, the composite knowledge base documents identified information about accessible services/components, while the composite service catalog documents all identified/known available implementations of the various identified services/components. The machine learning leverages, in combination, Big Data computer processing, programmatic natural language recognition/processing, and programmatic sentiment analysis from social media to learn and document within the composite knowledge bases information about the respective service and component offerings, and implementations, respectively, that would otherwise not be integrated into or usable within a single tool. As such, the composite knowledge bases constructed by machine learning provide new technological possibilities and service solution insights that may be leveraged by machine application of the learned knowledge.

In conjunction with the machine learning to continually construct and improve the two knowledge bases, the computational processing described herein performs machine learning and machine-based application of the machine-learned knowledge to programmatically evaluate new service solution objectives in view of that knowledge. The computational processing described herein provides specifications and/or recommendations by which to integrate the functionality of components from disparately-sourced products and/or services to implement the new service solution. The technology further performs gap analysis to identify opportunities for improvement of new service solutions, such as new features that are available for use and improvements that were not conceived of or referenced within the specified service solution objectives.

The technological computing platform described herein may autonomously derive its own service solutions from stated objectives. The stated objectives may be verbally entered by a service solution architect using high-level verbal statements, and the computing platform may programmatically interpret the stated objectives using natural language recognition/processing to arrive at a fully-specified service solution.

As such, by leveraging computer-based machine learning and machine application of knowledge as technological computing platform improvements over conventional technologies, the technology described herein provides a comprehensive computing tool/platform by which to identify service solutions that would not otherwise be identified using conventional platform-centric solution architecture tools or using human efforts. By use of this innovative combination of technologies, the system(s) described herein arrive, through machine learning, at a more comprehensive and thorough set of information, and arrive, through machine application of knowledge, at more accurate and improved service solutions that would otherwise not be identifiable by use of conventional technologies or by use of human research. As such, the technology described herein provides programmatic processing that improves upon and outperforms prior conventional platform-centric architectural solution tools.

Terminology used in describing certain embodiments of the present invention will now be explained. The terms “service solution,” “solution,” or “full service management chain” are used interchangeably herein and are hereby defined as an architected tool chain constructed from integrated component software/service products/modules to provide a full/operative service. The full/operative service includes a set of available service features as part of service operational processing. The features may include service monitoring of the various components and service features, event consolidation from various service components, social media integration, service alerting and issue ticketing related to any run-time/programmatic issues associated with the service, and other service-centric processing. Service solutions are hosted upon one or more/sets of computers to provide sets of service features that may be accessed using an integrated programmatic and/or user interface.

The term “Big Data” is hereby defined as voluminous data that requires advanced computational platforms (e.g., cloud and Hybrid cloud) to be processed. Big Data results from extensive data sets that cannot be processed by conventional computers due to the size/amount of data and dimensions of the data involved. “Big Data processing” improves computing technology by processing data of such dimensions.

The term “machine learning” is hereby defined as a computer system performing its own navigation of information resources (e.g., websites, etc.), performing its own analysis and retrieval of information about services/components hosted at the various information resources, and building its own computer-based body of knowledge from which to perform computer-based analysis of problems to be solved by the computer system. Machine learning improves computer processing by performing advanced research, analytics, evaluations, and result adaptation completely by the computing platform (e.g., without human interaction).

The term “natural language processing” is hereby defined as computer-based linguistic analysis of text and/or audio identified through machine-learning navigation and computer-based accesses of various information resources. The term “sentiment analysis” is hereby defined as the use of natural language processing to infer insights (e.g., emotions, feelings, thoughts, etc.) that may be programmatically derived from commentary posted by web-users at various information resources (e.g., where a user posts the word “useful” in association with a particular component or feature, the computer may infer that the user may recommend the particular component or feature for use in future service developments). Natural language processing and sentiment analysis when utilized as described herein in conjunction with machine learning allow a computer platform to apply advanced programmatic reasoning to disparate types of information as part of autonomous computer research (e.g., web searches, etc.).

The term “composite” as it applies to a service solution is hereby defined as a combination of service components from different vendor sources and/or open source computing platforms (e.g., different developers, different PaaS providers, different SaaS providers, open-source websites, etc.) that are programmatically integrated to arrive at a service solution with combinations of features that are unavailable from any single specific vendor. The term “architectural composite service solution” or “composite service solution” is/are hereby defined as a service solution constructed as a chain of different component service modules that originate from different vendors and/or open source computing platforms to provide a designated feature set/service. Composite service solutions as defined herein provide a customized computer-identified integration of components that allows interoperation between/among each multi-vendor pair or set of service modules in a tool chain, and thereby advances computing technology by improving computer-identified interoperation of services/components.

The term “composite knowledge base” is hereby defined as a programmatically-derived body of knowledge about identified/available service components/tools learned by a computer system through application of machine learning to the Internet and various web-based platforms, including PaaS, SaaS, social media, and other Web service sites. Details of implementation, use, and availability options for accessing generally-available services are included in the composite knowledge base. The term “composite service catalog” is hereby defined as a programmatically-derived body of knowledge about identified/available services that have been previously developed and deployed learned by a computer system through application of machine learning to the Internet and various web-based platforms, including PaaS, SaaS, social media, and other Web service sites. Details related to actual implementations of particular tools/services are included within the composite service catalog. The composite knowledge base and the composite service catalog individually and collectively improve computing technology by assembling/compiling/deriving new data resources that did not previously exist, and that may be leveraged to programmatically define new services solutions.

The term “common protocol” is defined herein as a technologically improved approach to integrating differing-protocol component service modules that originate from different vendors and/or open source computing platforms to improve the interoperation of the disparate service modules. By use of a common protocol for integration of different service modules, as described herein, a shared set of protocols may be adapted to the respective protocols of different integrated service modules to provide improved computer access to service features, service monitoring, and service alerting while still allowing use of service modules that utilize different protocols for accessing embedded features of the respective modules.

The technology described herein operates by creating, by machine-controlled web navigation and machine learning, each of: (1) a composite knowledge base of service components, with each service component in the composite knowledge base defined by (i) features that are offered, and (ii) how the respective service component connects and exchanges data with other service components; and (2) a composite service catalog including identified available implementations of the service components. Using machine-based application of machine-learned knowledge created within the composite knowledge base and the composite service catalog, the service component definitions are applied to a service solution under development to identify at least one service component usable to provide a technological improvement of the service solution under development. A service technology improvement report is outputted that details the technological improvement of the service solution under development provided by the identified at least one service component.

As described in detail further below, the technology described herein performs, as a machine-learning phase of programmatic processing, automated machine-controlled web navigation to a set of disparate web-based data sources, and natural language processing of content about reusable service components published at the disparate web-based data sources to derive a composite machine-created knowledge base of information about the available service components. The technology further performs, as a machine-application-of-knowledge-learned phase of the programmatic processing, analysis of a service solution under development using the machine-created knowledge base to identify at least one of the reusable service components usable to technologically improve services provided by the service solution under development. The technology further provides a reusable service component integration recommendation that specifies integration details of the at least one of the reusable service components into the service solution under development that technologically improves the services provided by the service solution under development.

As another alternative, the technology described herein creates, by automated web navigation to disparate unstructured data sources (e.g., web sites, social media sites, etc.) and using natural language processing of content at the disparate unstructured data sources, structured information usable for automated processing in solution gap recognition. The technology uses the structured information to identify a gap of a solution. The technology identifies a component and programmatic integration of the component that repairs/fills the identified gap.

It should be noted that conception of the present subject matter resulted from recognition of certain limitations associated with use of conventional platform-based hosted software service-oriented products, such as platform-as-a-service (PaaS) products. For example, it was observed that while platform-based service-oriented platforms provide an integrated set of components that may be used to form a software-based solution, the platform-centric nature of the component selection prohibited use and integration of other third-party components, such as open source components or software-as-a-service components developed by third-party (e.g., smaller) companies. Further, it was observed that the vastness of the Internet (e.g., the world wide web) itself imposed a limitation on human searching to find and analyze other/new component offerings from other vendors because a human cannot reasonably access, evaluate, and remember every possible search result (e.g., humans by nature look at only the first page of links and disregard what is on the hundreds of other pages of links). It was observed that a given cloud architect may miss/forget something important. It was observed that user-driven navigation of the full service offering universe is random in nature, and as a result, carries a large risk of an individual cloud/system architect missing something interesting or critical to a new development project that may improve the functionality/functioning of the developed computing solution and/or dramatically improve the development timeline. It was further determined that if a cloud/system architect is working on a new/custom solution for which no existing solution can be found, if that architect were to identify different components from different vendors that may be suitable for use in a new software solution, that architect would have to manually evaluate disparate/different interfaces provided by the different vendors, and may or may not be able to effectively integrate the disparate components due to some unknown/unpublished incompatibility. It was determined that other architects and component users may have used components or implemented components/systems differently from one another and in a manner that is unknown to a given system architect, and that these users may eventually share their experiences on the web (e.g., best practices, reusable design patterns, issues identified, workarounds, etc.). While social media websites provide platforms by which users may share experiences with integration and development of new software components/services, the ever-increasing number of social media platforms and the vastness of the Internet becomes prohibitive (impossible) for effective/comprehensive human searching of all published information, and a human could not assemble and process all published information. It was additionally observed that published information from component developers and from users regarding user experiences with software components is often distributed across multiple websites (e.g., company websites and social media websites), and that assimilation of the disparate pieces of knowledge into usable forms is not possible without use of an advanced computing technological platform and use of an advanced computing solution.

It was determined from these several observations that there was no existing technological computing platform that could programmatically provide composite component service-solution integration recommendations by use of programmatic evaluation of disparate data sources (e.g., company websites, social media commentary, etc.). The technology described herein provides an advanced computing platform that identifies component integration (composite) solutions autonomously. The technology described herein provides an architectural composite service solution builder. The architectural composite service solution builder benefits from machine-application of new technologies for Big Data processing by computers, natural language recognition/processing, and sentiment analysis from social media. The architectural composite service solution builder helps the cloud architect that is building a Hybrid/PaaS solution by automatically identifying gaps of available features in a current architectural solution, and by proposing possible new solutions and composite component integrations to enhance both the performance of and the development of the resulting service solution. Where a given PaaS vendor offers a new component that is unknown to the architect, there is no need for the cloud architect to search on the web.

To implement these several identified technological improvements and overcome the recognized problems with conventional technologies, the architectural composite service solution builder performs two distinct phases of computer-based operations: (1) machine learning; and (2) machine application of knowledge learned. During the machine-learning phase, the architectural composite service solution builder builds the two composite knowledge bases that integrate knowledge of at least (i) all identifiable service components/modules provided by all identifiable PaaS, SaaS, and open source vendors and all identifiable service solutions, (ii) design best practices and design patterns within which the various identified service solutions/components/modules have been applied, and (iii) information obtained from a variety of web domains (e.g., social media websites) in which service solution developers post information about lessons learned, techniques for efficient use of services/components/modules (e.g., collectively “tools”), and other developer-originated socially-shared information usable to evaluate use of the various identified services/components/modules. During the machine-based application of knowledge learned phase, the architectural composite service solution builder applies the composite knowledge base to a new service solution problem by (i) evaluating either a designated/intended solution as specified by a cloud architect and/or evaluates an intermediate stage of development of a particular solution, and (ii) identifying operational gaps in either components/features, integration requirements, usability, or other aspects of interoperation of disparate services/components/modules from different sources that are available to be used to provide the designated/intended solution.

As such, the technology described herein creates a self-learning and self-applying computer system that may in turn help service architects and service developers create new user applications. Using this solution, the architect/developer may focus on the specific features of the target application while leaving all the infrastructural aspects (e.g., monitoring, high availability, security, ticket management, etc.) to the self-learning and self-applying computer system. The self-learning and self-applying computer system may quickly provide an integrated common protocol solution in real-time that is more robust and more reliable than what any human architect could develop because of the advancements in real-time problem solving provided by the computing platform itself.

Machine Learning

The architectural composite service solution builder maintains two (2) new sets of programmatically-collected and programmatically-managed information. The first new set of information is a composite knowledge base. The second new set of information is a composite service catalog. Each of these new sets of information will be described in more detail below.

Machine-based cognitive technologies (e.g., Big Data processing, programmatic natural language processing, and sentiment analysis) may be used by the architectural composite service solution builder to construct and maintain these knowledge bases. The architectural composite service solution builder may scan through the web, through all the social media, and through any possible other sources of information, to learn specific features for each tool as well as expressed user feelings/sentiments for each tool. The architectural composite service solution builder may read and interpret natural language formatting and may detect commentary entered (e.g., postings, etc.) by users of different component and service platforms.

As part of this machine-based cognitive technology processing, the architectural composite service solution builder provides an initial programmatic evaluation for each retrieved tool (e.g., service or component, etc.). This detailed information is stored within the composite knowledge base and/or the composite service catalog, and may be used to provide component integration recommendations with common protocol adaptations of the various component interfaces to system architects that utilize the services provided by the architectural composite service solution builder.

The following several paragraphs provide a partial set of information items that the architectural composite service solution builder may detect about any given service/component (e.g., tool), again using at least in part natural language recognition. As a first example information item, the source of detected information, such as a social media website and community where people talk about the tool (e.g., website and web feed channels), may be captured. Additional information that may be captured may include positive and/or negative comments about the tool (e.g., from people that are satisfied and dissatisfied with use of various components). Tips, techniques, and related information about the use of a particular tool may be captured. Information suggesting a number of implementations of the tool may be captured (e.g., where a web feed shows a long history of postings related to a tool, it is highly likely that users of the web feed eventually decided to implement the tool).

Additionally, information regarding how many people discontinued use of the given tool and selected a competitive tool may be captured (e.g., for this information some form of cross check may be implemented to help confirm reasoning for switching from one tool to another). Within this example set of information, if toolA and toolB are two competitive tools, the architectural composite service solution builder may detect two different web feed channels, one channel for each product, and may search for postings from the same user-id (e.g., if there is a user that has posted on both the channels, he/she was likely trying to decide which tool to use). The architectural composite service solution builder may present the final result, present various details about the selection process as derived from the postings, and may even present a list of users on social media that may be contacted for feedback and additional information.

Information regarding how well established and mature the particular tool is in the market may be captured (e.g., a tool may be in use for years, or may be a very new tool). This form of information may further document derived benefits of very new technologies, while also revealing whether a tool is mature enough for production without further testing considerations.

This evaluation by the architectural composite service solution builder may be further extended by listing pros and cons of each particular tool, which may require further use of programmatic cognitive skills. Information derived may further include a list of available interfaces, a list of protocols by which the available interfaces may be used, and a list of additional features provided by a particular tool. For example, while searching for a “logging” tool, the architectural composite service solution builder may discover that the tool also provides a capability for creating custom dashboards (e.g., a custom user interface). While this additional feature may not be a main decision point for use of the tool, documenting this additional feature may assist with creating a final ranking for the tool, such as where a competitive tool does not provide the capability of creating a custom dashboard.

As such, the technology described herein programmatically derives the composite knowledge base to provide new information (e.g., best practices/patterns) that is not available on any given platform. The architectural composite service solution builder automatically scans a pattern and creates from it a structured entry that lists specific details. For example, the information captured within a structured entry for a particular tool may include the provided functionality and the service that this entry describes (e.g., Event Consolidation).

The information captured within a structured entry for a particular tool may include a list of possible interactions (e.g., both input interactions and output interactions—events that may result from a monitoring or notification service). Events may be used to create an entry on a social media website, to search in a repository of automatic known solutions, to create a ticket, or for other reasons. The architectural composite service solution builder utilizes these various sources of information to cross-check possible integrations of the respective tool with other services.

The information captured within a structured entry for a particular tool may include a list of currently available implementations of the service, from any vendor on the market. For example, the architectural composite service solution builder may maintain a reference to the source for the particular tool, and may maintain references to sources of similar products from other vendors. This set of fields may be utilized to routinely scan though the web to search for the latest implementations of the respective tools, and to update the information maintained in the knowledge bases.

The information captured within a structured entry for a particular tool may include the supported service/component protocol(s), the common protocol adaptations that may allow efficient integration of the respective service/component with other services/components, and how each pair of documented components/services may communicate and integrate to enhance individual service offerings of the respective components/services. For example, event consolidation systems may be configured to accept requests via simple network management protocol (SNMP), emails, or other communication technologies using a common protocol/pattern defined by the architectural composite service solution builder.

These common protocols/patterns may further be adopted over time by different vendors as standard interface specifications for the various tools as the benefits of component/service integration provided by the technology described herein increases use and utility of the components/services offered by the different vendors. As such, the different vendors may thereby be incentivized by more visibility in the market place to adopt the common protocol interface(s) defined initially for the various components by the architectural composite service solution builder.

As can be seen from this set of example information alone, the landscape of design pattern reuse is exponential. As a result, the computational processing described herein is needed because a human being is incapable of processing the volume of information that is available on the web. By performing the structured computer processing described herein, automated processing may be implemented via a computer system (e.g., an advanced technology Cloud computer system) to provide a level of information that may not be otherwise obtained and utilized without this form of advanced computing platform.

An example, non-exhaustive, structured entry to the composite knowledge base for an example component named “synthetic monitoring” may include the following information:
Synthetic monitoring (entry):
   service creates automated test for periodic application availability check;
   service performs via HTTP test, via API invocations, or using complex recorded scripts that represents a full user scenario on the target application;
   response time and alerts from this service should be sent to object servers and social media;
   integration may be implemented via SNMP messages, emails or SMS;
   Vendor XYZ offers this service via the component XYZ.MON, vendor ABC offers this service via the component ABC.MTOOL;
   list of pros and cons of using this service;
   tips; and
   use suggestions.

Acronyms within the example above include hypertext transfer protocol (HTTP), application programing interface (API), simple network management protocol (SNMP), and short message service (SMS).

As can be seen from this example entry within the composite knowledge base, details of implementation, use, and availability options for accessing the example service are included. As such, these learned details include information programmatically derived from web-based searches by use of programmatic natural language recognition of content (e.g., list of pros and cons of using the service, tips, use suggestions, etc.). Aspects of this derived information represent a compendium of use, and of user experiences with the use of the respective services/components.

Regarding the composite service catalog, this catalog, when compared to the composite knowledge base, provides a next level of details related to the particular tools that are documented within the composite knowledge base. While the composite knowledge base documents information about generally-available services/components, the composite service catalog lists all identified/known available implementations.

Information that may be obtained from tool providers and documented for each identified/known implementation includes the list of provided features (e.g., logging and dashboarding), and a list of available interfaces/supported protocol, each as described in detail above. The composite service catalog extends this source catalog information by the addition of a social review field, and a list of pros and cons discovered by reading natural language comments from users, again at the identified/known implementation level as opposed to the component level (as in the composite knowledge base). This augmented information may again be derived using the same algorithmic and natural language processing described above for identification of information related to individual tools.

By constructing, maintaining, and using these knowledge bases/service catalogs, the present subject matter improves service-oriented solution building by providing an architectural composite service solution builder tool, as described above and in more detail below. As such, improved integration of differing-protocol service modules may be obtained through use of the present technology.

As introduced above, the architectural composite service solution builder maintains a composite knowledge base that contains all information derived from analysis of previously-deployed solutions, knowledge added responsive to analysis of developer comments, any identified documents that identify implementation or other details of previously-deployed solutions, and results of periodic web searches of the disparate data sources. Extensive use of programmatic natural language pattern recognition may be applied to the various disparate data sources to automatically detect newly-generated information, derive useful service solution details from the newly-generated information, and to generate new entries and metadata to store the new service solution details within the composite knowledge base. Entries within the composite knowledge base for a given deployed service or component may include, among other details, a list of features provided by a particular deployed service/component, a list of other services that according to best practices have data available about the deployment(s) of the respective service/component, a list of currently available implementations of the service/component (either from the same cloud solution or from other deployed solution), and integration protocol(s) of the respective service/component (e.g., how to utilize the published interface(s) of the respective element). As such, the composite knowledge base provides a consolidated programmatically-created and programmatically-accessible information source from which to leverage detailed information for development of new service solutions.

As also introduced above, the architectural composite service solution builder maintains a composite service catalog that contains all identifiable/known implementations of services and components. The composite service catalog augments any identifiable published information about the respective services/components (e.g., such as information obtained from PaaS or SaaS services that deploy the respective elements) with additional detailed information usable for cross-platform integration of the services and/or components, as programmatically derived from the disparate data sources (e.g., social media, publications, etc.). For each service and component listed within the composite service catalog, the new information learned about the respective elements may include a list of provided features, a list of available interfaces, a list of available protocols, protocol use details, information related to integration of the respective services/components, and other information obtained from the various disparate data sources.

To build the composite knowledge base and the composite service catalog, the architectural composite service solution builder automatically searches the Internet/Web and identifies different service solutions and service solution components published/offered by different PaaS, SaaS, and open source vendors. The architectural composite service solution builder further searches social media websites for developer comments provided in many different formats across the different websites, and applies natural language processing of the comments to extract useable/critical information about the use and integration of components that would otherwise not be available to cloud architects.

Machine Application of Machine-Learned Knowledge

To apply the composite knowledge base and composite service catalog to a new service solution problem while building a new application, the architectural composite service solution builder periodically executes algorithmic processing that compares current architectural implementation of the new solution under development with other solutions the architectural composite service solution builder already knows about (e.g., from the machine-learning phase). When a feature/functional gap is identified in the solution under development, the architect is notified with a recommendation of one or more suggested components that may be integrated to fill in the identified gap. The architect may provide a final decision regarding whether to request the architectural composite service solution builder to integrate the identified component(s) to fill the identified gap (e.g., by adding the suggested component(s)). More details of the specific algorithmic processing of the architectural composite service solution builder are described below in association with the detailed flowcharts.

Iterating the Machine Learning and Machine Application of Knowledge

The architectural composite service solution builder may continuously or periodically iterate machine learning processing and machine application of knowledge learned processing. Additionally, the architectural composite service solution builder may take into consideration and resolve cascaded dependencies as it progresses through machine-based identification of the new service solution. As such, the architectural composite service solution builder learns more at each execution cycle, and may suggest how to improve the target service/solution/application at each iteration of knowledge and at each iteration of processing of a particular service/solution/application under development.

For example, if a decision at one position in a chain of tools to be implemented is to be made between a SaaS logging service (e.g., one available from a particular Cloud solution provider) or an on-premise logging service (e.g., an open-source logging tool), the architectural composite service solution builder may iterate the decision process to the next chain step and describe which other tools may plug in to each of the respective choices. To further this example, if the first logging alternative cannot send alerts when receiving a given message while the second alternative can send alerts in this situation, the architectural composite service solution builder may take into consideration these types of cascaded dependencies and may propose that the entire cascaded tool chain include the first logging alternative to provide the greatest flexibility of service implementation.

As such, the architectural composite service solution builder may build a full tool chain on its own, starting from any given/specified point in a particular service. For example, the architect may just input (again in a natural language manner): “I want to have active (synthetic) monitoring on my application and a focus is to reduce the down time of the application.” By further use of natural language processing, the architectural composite service solution builder may start evaluating the alternative identified components that provide synthetic monitoring, may look at what the next tool options for the chain expect as inputs and provide as outputs, and may iterate through alternative permutations in a highly-efficient real-time manner. The architectural composite service solution builder may build an alternative tool chain graph that rates all of the possible tool chains and tool chain alternatives. If there is already a full or partial tool chain in place, the architectural composite service solution builder may evaluate it among the set of alternatives, and may determine how close the existing full or partial tool chain is to the “ideal” solution it has just defined.

Feedback

All of the above information may now be presented to the solution architect as a report. The architectural composite service solution builder may, as implementation alternatives, present a report for each evaluated tool, may build a gap analysis table, may rate each tool according to an array of details identified, may discard those alternatives that have too low of a rating, and may present only the best-rated alternatives to the architect.

The architectural composite service solution builder may also be used by those developing cloud services (e.g., if company A develops tool T for service S). The architectural composite service solution builder may run a competitive analysis between the tool under development and other similar tools. The architectural composite service solution builder may gather and provide feedback, and may provide suggestions for improvement of the tool under development (e.g., suggestions of additional component(s) that provide feature(s) usable in conjunction with currently-developed feature(s), etc.).

The processing associated with the architectural composite service solution builder described herein may be performed in real time to allow prompt construction of service-solution integration protocols for construction of architected tool-chains of service-oriented solution components. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

Additional details of the algorithmic processing and computational efficiencies will be provided further below. The following portion of the present description provides examples of advanced computational platform(s) within which the present technology may be implemented, followed by further details of the architectural composite service solution builder described herein.

It should be noted that the present technology may be implemented within or as part of a cloud computing environment (e.g., for data analytics), or may be implemented as a customized environment-specific solution. As such, examples of implementations for both environments are included herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

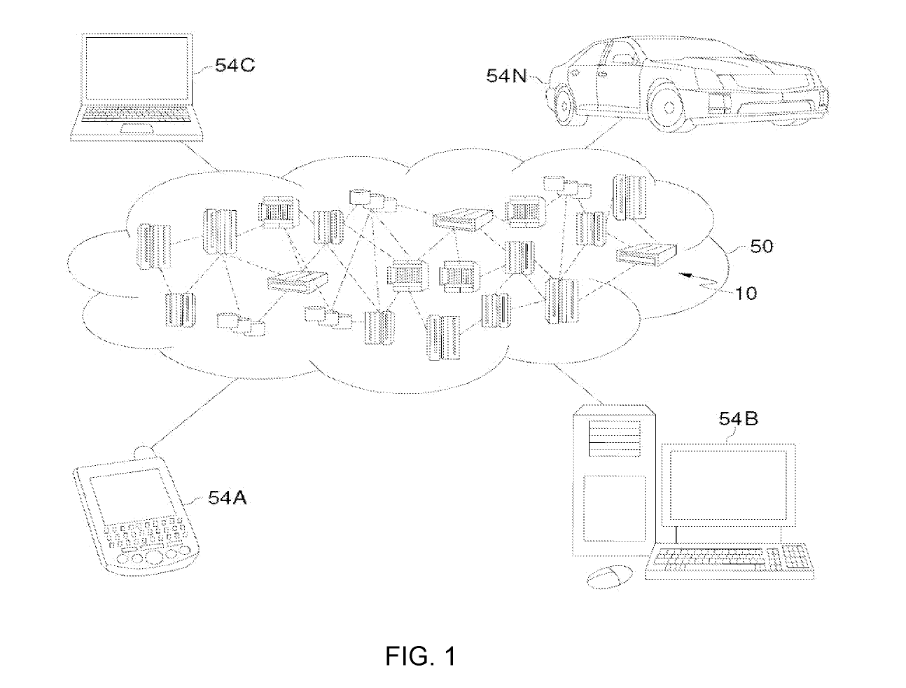

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

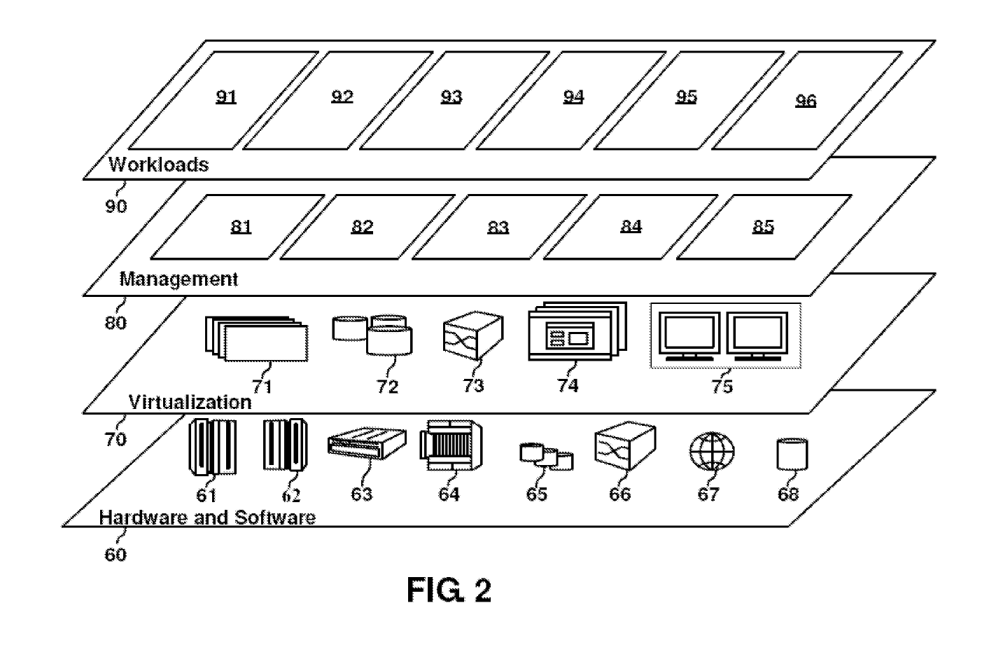

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and architectural composite service solution builder 96.

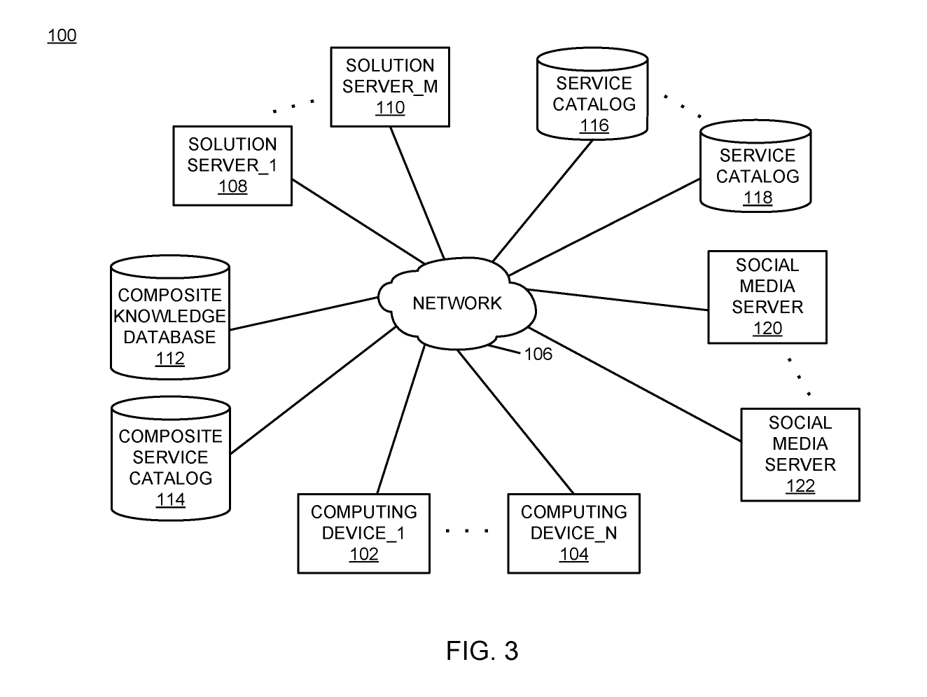

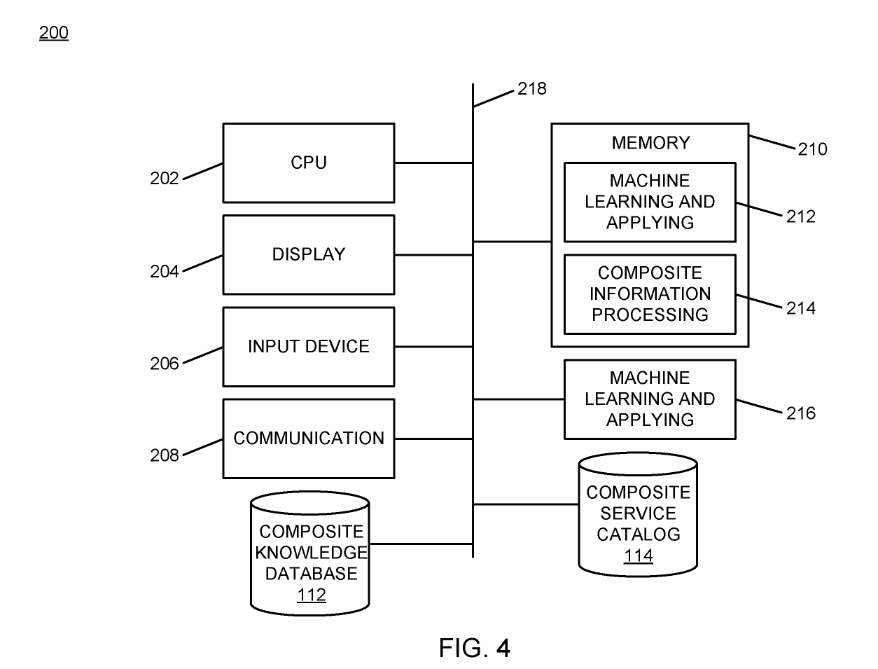

Regarding alternative platform implementation options, FIGS. 3 and 4 below are directed to such alternatives. It should be understood that the various alternatives may be combined with or substituted with the implementation options described above and below, as appropriate for the given implementation.

FIG. 3 is a block diagram of an example of an implementation of an alternative system 100 for implementation of an architectural composite service solution builder. A computing device_1 102 through a computing device_N 104 represent a set of user-level computing devices that may be used by service architects/developers and other Internet users to communicate via a network 106 with several other devices. Certain of the other devices used to provide the architectural composite service solution builder include a solution server_1 108 through a solution server_M 110, a composite knowledge database 112 and a composite service catalog 114. As described above, and in more detail below, the solution server_1 108 through the solution server_M 110 may interact and collaborate to provide an architectural composite service solution builder tool that navigates web-accessible resources to build knowledge about identified/available services/components within the composite knowledge database 112 and a composite service catalog 114. Within the present example, certain web-accessible resources are depicted without limitation, and include a service catalog 116 through a service catalog 118, and a social media server 120 through a social media server 122. The solution server_1 108 through the solution server_M 110 may navigate via the network 106 to each of the various web-accessible resources to learn about available services/components (e.g., tools) that may be utilized to build new applications/services, and may learn user experiences (e.g., best practices, etc.) and sentiments about the various tools from social media postings. It is understood that many other forms of web-accessible resources may be accessed, and machine learning may be used by the solution server_1 108 through the solution server_M 110 to build knowledge about the various identified tools.

As will be described in more detail below in association with FIG. 4 through FIG. 6, the solution server_1 108 through the solution server_M 110 may each or in combination provide an automated architectural composite service solution builder. The automated architectural composite service solution builder is based upon machine-based evaluation of published service information, including natural language published service information, social media postings, usage statistics and other information to determine the usability of service-oriented solution components for a new particular specified composite solution. The architectural composite service solution builder described herein provides service-oriented component recommendations that would not be possible without the automated web-based navigation and machine-based learning described herein.

In view of the implementation alternatives described above, the present technology may be implemented within a cloud computing platform, at a user computing device, at a server device level, or by a combination of such platforms and devices as appropriate for a given implementation. A variety of possibilities exist for implementation of the present subject matter, and all such possibilities are considered within the scope of the present subject matter.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The solution server_1 108 through the solution server_M 110 may include any device capable of providing data for consumption by a device, such as the computing device_1 102 through the computing device_N 104, via a network, such as the network 106. As such, the solution server_1 108 through the solution server_M 110 may each include a web server, application server, or other data server device.

The composite knowledge database 112 and the composite service catalog 114 may each include a relational database, an object database, or any other storage type of device, and may alternatively include a server-type computing device. As such, the composite knowledge database 112 and the composite service catalog 114 may be implemented as appropriate for a given implementation.

The service catalog 116 through the service catalog 118 and the social media server 120 through the social media server 122 represent additional computing devices that may be accessed via a network, such as the network 106. These additional devices may also be implemented as appropriate for a given implementation.

FIG. 4 is a block diagram of an example of an implementation of a core processing module 200 capable of operating as an architectural composite service solution builder. The core processing module 200 may be associated with either the computing device_1 102 through the computing device_N 104, with the server_1 108 through the server_M 110, or with devices within the cloud computing environment 50, as appropriate for a given implementation. As such, the core processing module 200 is described generally herein, though it is understood that many variations on implementation of the components within the core processing module 200 are possible and all such variations are within the scope of the present subject matter. Further, the core processing module 200 may be implemented as an embedded processing device with circuitry designed specifically to perform the processing described herein as appropriate for a given implementation.

Further, the core processing module 200 may provide different and complementary processing for autonomous machine-created composite service solutions in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 (“processor”) provides hardware that performs computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, voice command processing unit, or any other type of input device by which the user may interact with and respond to information on the display 204.

It should be noted that the display 204 and the input device 206 may be optional components for the core processing module 200 for certain implementations/devices, or may be located remotely from the respective devices and hosted by another computing device that is in communication with the respective devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides hardware, protocol stack processing, and interconnection capabilities that allow the core processing module 200 to communicate with other modules within the system 100, or within the cloud computing environment 50, as appropriate for a given implementation. The communication module 208 may include any electrical, protocol, and protocol conversion capabilities useable to provide interconnection capabilities, as appropriate for a given implementation. As such, the communication module 208 represents a communication device capable of carrying out communications with other devices.

A memory 210 includes a machine learning and applying storage area 212 that provides processing and storage for use during machine learning and applying of machine-learned knowledge within the core processing module 200. The memory 210 also includes a composite information processing storage area 214 that provides processing and storage for use during composite service solution development (e.g., alternative tool chain graphs, reporting features, performance predictions, etc.) within the core processing module 200.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A machine learning and applying module 216 is also illustrated. The machine learning and applying module 216 provides advanced computational processing within the core processing module for autonomous development of composite service solutions within the core processing module 200, as described above and in more detail below. The machine learning and applying module 216 implements the automated architectural composite service solution builder of the core processing module 200. The machine learning and applying module 216 may be considered a collaborative computing device that operates across a set of physical computing platforms (e.g., within a cloud computing environment or otherwise), and composite service solutions may be derived by collaborative autonomous computer integrated processing.

It should also be noted that the machine learning and applying module 216 may form a portion of other circuitry described without departure from the scope of the present subject matter. The machine learning and applying module 216 may form a portion of an interrupt service routine (ISR), a portion of an operating system, or a portion of an application without departure from the scope of the present subject matter. The machine learning and applying module 216 may also include an embedded device with circuitry designed specifically to perform the processing described herein as appropriate for a given implementation.

The composite knowledge base 112 and the composite service catalog 114 are again shown within FIG. 4 associated with the core processing module 200. As such, the composite knowledge base 112 and the composite service catalog 114 may be operatively coupled to the core processing module 200 without use of network connectivity, as appropriate for a given implementation.

The CPU 202, the display 204, the input device 206, the communication module 208, the memory 210, the machine learning and applying module 216, the composite knowledge base 112, and the composite service catalog 114 are interconnected via an interconnection 218. The interconnection 218 may include a system bus, a network, or any other interconnection capable of providing the respective components with suitable interconnection for the respective purpose.

Though the different modules illustrated within FIG. 4 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. Many other possible arrangements for components of the core processing module 200 are possible and all are considered within the scope of the present subject matter. It should also be understood that, though the composite knowledge base 112 and the composite service catalog 114 are illustrated as separate components for purposes of example, the information stored within the respective knowledge bases may also/alternatively be stored within the memory 210 without departure from the scope of the present subject matter. Accordingly, the core processing module 200 may take many forms and may be associated with many platforms.

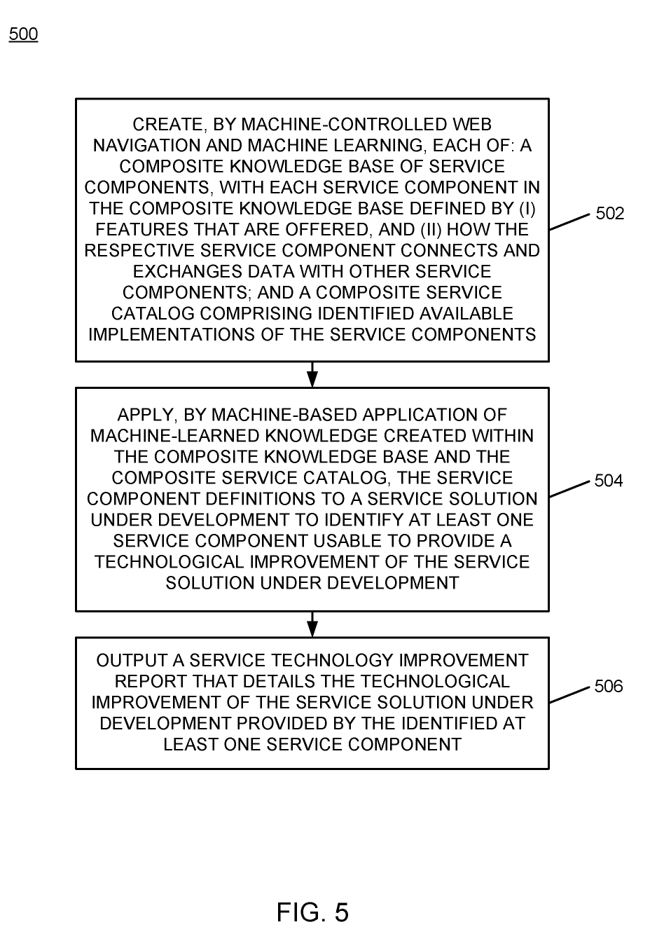

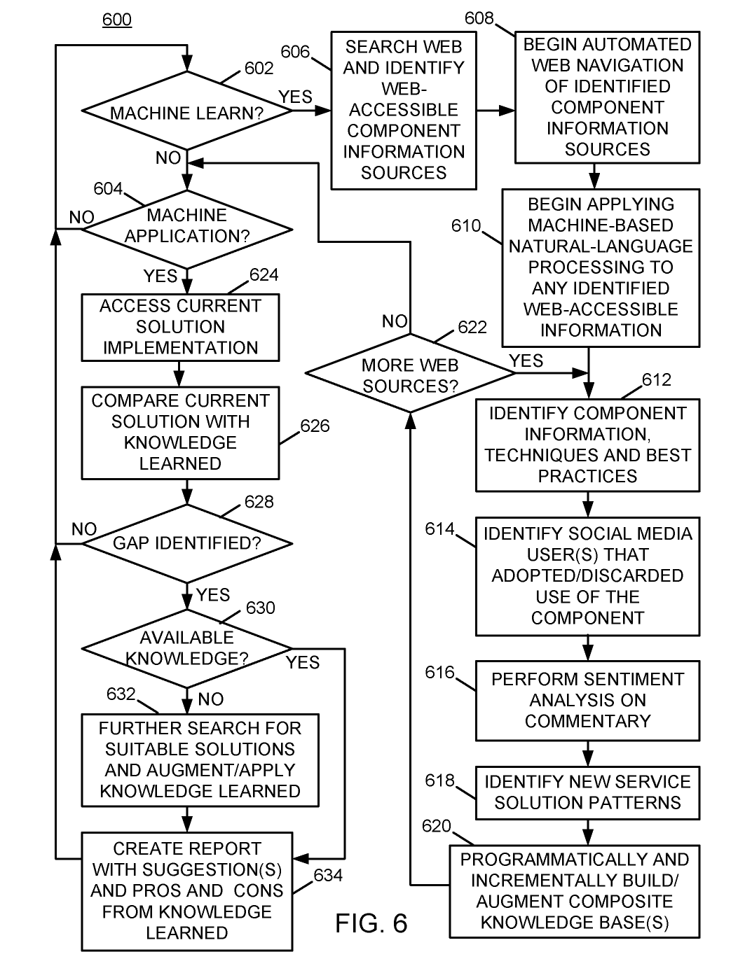

FIG. 5 through FIG. 6 described below represent example processes that may be executed by devices, such as the core processing module 200, to perform the automated architectural composite service solution builder associated with the present subject matter. Many other variations on the example processes are possible and all are considered within the scope of the present subject matter. The example processes may be performed by modules, such as the machine learning and applying module 216 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 5 is a flow chart of an example of an implementation of a process 500 for an architectural composite service solution builder. The process 500 represents a computer-implemented method of performing the architectural composite service solution builder described herein. At block 502, the process 500 creates, by machine-controlled web navigation and machine learning, each of: a composite knowledge base of service components, with each service component in the composite knowledge base defined by (i) features that are offered, and (ii) how the respective service component connects and exchanges data with other service components; and a composite service catalog comprising identified available implementations of the service components. At block 504, the process 500 applies, by machine-based application of machine-learned knowledge created within the composite knowledge base and the composite service catalog, the service component definitions to a service solution under development to identify at least one service component usable to provide a technological improvement of the service solution under development. At block 506, the process 500 outputs a service technology improvement report that details the technological improvement of the service solution under development provided by the identified at least one service component.

FIG. 6 is a flow chart of an example of an implementation of a process 600 for an architectural composite service solution builder that provides additional technical details of each of the machine learning processing and the machine-based application of knowledge processing. The process 600 represents a computer-implemented method of performing the architectural composite service solution builder described herein. At decision point 602, the process 600 makes a determination as to whether to begin programmatic processing for machine learning. In response to determining at decision point 602 not to begin programmatic processing for machine learning, the process 600 makes a determination at decision point 604 as to whether to begin processing for machine-based application of machine-learned knowledge. In response to determining at decision point 604 not to begin processing for machine-based application of machine-learned knowledge, the process 600 returns to decision point 602 and iterates as described above.

In response to determining at decision point 602 to begin programmatic processing for machine learning, at block 606 the process 600 searches the web (e.g., Internet and other web-accessible published information) and identifies web-accessible component information sources. For purposes of this description, a “component” is defined as any existing sub-components, existing service solutions, existing service solution patterns, existing tools, or other reusable service elements that may be considered for use in autonomous development of composite service solutions. As described above, web-accessible component information sources may include component providers such as platform as a service (PaaS) architectural environments and/or software as a service (SaaS) environments. Web-accessible component information sources may also include social media or other websites where service architects share information about the use of components, including any lessons learned or best practices for integration of components, and any sentiments regarding components.

In response to identifying all available Web-accessible component information sources, the process 600 begins automated navigation of the identified component information sources at block 608. As described above, in contrast to conventional approaches, the process 600 may navigate to “all” identified component information sources, and as such may form a more comprehensive base of knowledge of published information that is not possible by use of conventional computing platforms.

At block 610, the process 600 begins applying machine-based natural language processing to any identified web-accessible information at each accessed web-accessible information source. Again, in contrast to conventional approaches, the process 600 may apply machine-based natural language processing to “all” identified web-accessible information, and as such may form a more comprehensive base of knowledge of published information that is not possible by use of conventional computing platforms.

At block 612, the process 600 iterative processes of each accessed web information source and continues applying the machine-based natural language processing to all identified information. Specifically, at block 612, the process 600 identifies component information, techniques for implementation of components, and best practices. At block 614, the process 600 identifies social media users (e.g., user identifiers, topic streams, etc.) that adopted and/or discarded use of any component. At block 616, the process 600 performs sentiment analysis on any commentary identified about any component. At block 618, the process 600 identifies new service solution patterns that are documented and/or discussed by web users. At block 620, the process 600 programmatically and incrementally builds/augments the composite knowledge bases for each item of machine-learned information, specifically the composite knowledge base and the composite service catalog described in detail above.

At decision point 622, the process 600 makes a determination as to whether there are more web-accessible information sources that may be navigated. In response to determining that there are more web-accessible information sources that may be navigated, the process 600 navigates to the next web-accessible information source and returns to block 612 to process the next web-accessible information source as described above. The process 600 iterates across all web-accessible information sources and builds/augments the two composite knowledge bases for each item of machine-learned information, as described in detail above. In response to determining at decision point 622 that all web-accessible information sources have been processed, the process 600 returns to decision point 604 and iterates as described above.

Returning to the description of decision point 604, in response to determining to begin processing for machine-based application of machine-learned knowledge, the process 600 accesses the current solution implementation at block 624. As described above, the processing performed by the process 600 may be performed in a fully-automated manner based upon only a natural language input from a system architect. In such an implementation, the processing at block 624 may further apply natural language processing to the natural language input. As one example described above, the architect may just input (again in a natural language manner): “I want to have active (synthetic) monitoring on my application and a focus is to reduce the down time of the application.” By use of natural language processing, the process 600 may convert the natural language input into a computer-usable form usable to start evaluating the alternative identified components that provide synthetic monitoring, may look at what the next tool options for the chain expect as inputs and provide as outputs, and may iterate through alternative permutations in a highly-efficient real-time manner. As an alternative to natural language input, the processing at block 624 to access the current solution implementation may be applied incrementally to a service solution in any stage of development, whether in natural language or computer-implemented form as a developed full or partial solution, or a combination of the two. As such, the process 600 accesses the current solution implementation in its currently-available form.

At block 626, the process 600 compares the current solution implementation with knowledge learned during the machine-learning processing as documented within the composite knowledge bases. At decision point 628, the process 600 makes a determination as to whether any solution gaps have been identified. As described above, solution gaps may include omitted features, opportunities for feature improvement/enhancement, or any other form of gap in the current solution implementation. In response to determining at decision point 628 that no solution gap has been identified, the process 600 returns to decision point 602 and iterates as described above. The process 600 may output an acknowledgement to the solution architect that the current solution implementation complies with all known advanced implementation best practices, techniques, component selections, component integrations, and any other relevant information that documents the efficient utilization of components within the composite service solution.

Alternatively, in response to determining at decision point 628 that at least one solution gap has been identified, the process 600 makes a determination at decision point 630 as to whether there is available knowledge within the composite knowledge bases usable to fill the identified gap(s). In response to determining at decision point 630 that there is no available knowledge within the composite knowledge bases usable to fill the identified gap(s), at block 632 the process 600 further searches for suitable solutions (e.g., component and/or solution alternatives) and augments/applies any knowledge learned within the composite knowledge bases, as described above in association with the machine-learning processing.

In response to further searching for suitable solutions and augmenting/applying any knowledge learned within the composite knowledge bases at block 632, or in response to determining at decision point 630 that there is available knowledge within the composite knowledge bases usable to fill the identified gap(s), the process 600 creates a report with any suggestions and any identified pros and cons identified from the knowledge learned. The report may further include integration/interface specifications by use of common protocol integration techniques, and related information usable for evaluation of the suggestion(s). The process 600 may build an alternative tool chain graph that rates all of the possible tool chains and tool chain alternatives, and may output this alternative tool chain graph in conjunction with the reporting. In response to producing all relevant reporting details, the process 600 returns to decision point 602 and iterates as described above.

As such, the process 600 applies machine learning to identify and navigate web-based resources and programmatically extracts natural language information from which to programmatically build a variety of knowledge about available components. The process 600 performs machine-based application of knowledge learned to programmatically arrive at full specifications for a service solution, or to identify gaps and specifications from which to improve a service solution at any stage of development/deployment.

Some embodiments of the present invention may improve the technology of computers in one, or more, of the following ways: (i) autonomous machine-controlled searching and navigation of Internet websites; (ii) autonomous machine-learning by use of programmatic natural language recognition/processing and programmatic sentiment analysis from websites and social media to learn and document information about service and component offerings; (iii) autonomous machine-controlled application of knowledge with fully machine-architected composite service solutions; and (iv) autonomous machine-controlled integration of specifications for composite service solutions.

The present invention is not abstract because it relates particularly to computer operations and/or hardware for reasons that may include the following: (i) autonomous machine-controlled identification of Internet-based information resources from which to learn information by use of machine-based learning; (ii) autonomous machine-controlled identification of and machine determinations of relevance of information found in language-based formats on Internet-based information resources; (ii) fully machine-controlled architectural design and implementation of specifications for composite service solutions; and (iv) fully machine-controlled decision-making regarding composite service solution implementation alternatives.

As described above in association with FIG. 1 through FIG. 6, the example systems and processes provide an architectural composite service solution builder. Many other variations and additional activities associated with the architectural composite service solution builder are possible and all are considered within the scope of the present subject matter.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art based upon the teachings herein without departing from the scope and spirit of the invention. The subject matter was described to explain the principles of the invention and the practical application, and to enable others of ordinary skill in the art to understand the invention for various embodiments with various modifications as are suited to the particular use contemplated.

What is claimed is:

1. A computer-implemented method, comprising:
by a processor:
creating, by machine-controlled web navigation and machine learning, each of:
(1) a composite knowledge base of service components, with each service component in the composite knowledge base defined by (i) features that are offered, and (ii) how the respective service component connects and exchanges data with other service components; and
(2) a composite service catalog comprising identified available implementations of the service components;
applying, by machine-based application of machine-learned knowledge created within the composite knowledge base and the composite service catalog, the service component definitions to a service solution under development to identify at least one service component usable to provide a technological improvement of the service solution under development; and
outputting a service technology improvement report that details the technological improvement of the service solution under development provided by the identified at least one service component.

2. The computer-implemented method of claim 1, where the machine learning performed by the processor during the machine-controlled web navigation comprises machine-based natural language processing of content published by multiple different component vendor websites.

3. The computer-implemented method of claim 1, where the machine learning performed by the processor during the machine-controlled web navigation comprises machine-based natural language processing of content postings published at social media websites by users of the social media websites related to each of user experiences with the service components and techniques related to the use and integration of the service components.

4. The computer-implemented method of claim 1, where each service component in the composite knowledge base is further defined by best practices for use and integration of the respective service component into service solutions identified through machine-based natural language processing of content postings published at social media websites by users of the social media websites.

5. The computer-implemented method of claim 1, where:
the identified available implementations of the service components comprise tool chain specifications that detail use and integration of the service components into other service solutions; and
applying, by the machine-based application of the machine-learned knowledge created within the composite best practice knowledge base and the composite service catalog, the service component definitions to the service solution under development comprises performing a machine-controlled comparison of the tool chain specifications of the identified available implementations of the service components with a current tool chain implementation of the service solution under development.

6. The computer-implemented method of claim 1, where the service technology improvement report further identifies integration details of the at least identified one service component, that provides the technological improvement of the service solution under development, into the service solution under development.

7. The computer-implemented method of claim 1, where the machine learning and the machine-based application of machine-learned knowledge are provided as a service in a cloud computing environment.

8. A system, comprising:
a memory; and
a processor programmed to:
create, within the memory by machine-controlled web navigation and machine learning, each of:
(1) a composite knowledge base of service components, with each service component in the composite knowledge base defined by (i) features that are offered, and (ii) how the respective service component connects and exchanges data with other service components; and
(2) a composite service catalog comprising identified available implementations of the service components;
apply, by machine-based application of machine-learned knowledge created within the composite knowledge base and the composite service catalog, the service component definitions to a service solution under development to identify at least one service component usable to provide a technological improvement of the service solution under development; and
output a service technology improvement report that details the technological improvement of the service solution under development provided by the identified at least one service component.

9. The system of claim 8, where the machine learning performed by the processor during the machine-controlled web navigation comprises machine-based natural language processing of content published by multiple different component vendor websites.

10. The system of claim 8, where the machine learning performed by the processor during the machine-controlled web navigation comprises machine-based natural language processing of content postings published at social media websites by users of the social media websites related to each of user experiences with the service components and techniques related to the use and integration of the service components.

11. The system of claim 8, where each service component in the composite knowledge base is further defined by best practices for use and integration of the respective service component into service solutions identified through machine-based natural language processing of content postings published at social media websites by users of the social media websites.

12. The system of claim 8, where:
the identified available implementations of the service components comprise tool chain specifications that detail use and integration of the service components into other service solutions; and
in being programmed to apply, by the machine-based application of the machine-learned knowledge created within the composite best practice knowledge base and the composite service catalog, the service component definitions to the service solution under development, the processor is programmed to perform a machine-controlled comparison of the tool chain specifications of the identified available implementations of the service components with a current tool chain implementation of the service solution under development.

13. The system of claim 8, where:
the service technology improvement report further identifies integration details of the at least identified one service component, that provides the technological improvement of the service solution under development, into the service solution under development; and
the machine learning and the machine-based application of machine-learned knowledge are provided as a service in a cloud computing environment.

14. A computer program product, comprising:
a computer readable storage medium having computer readable program code embodied therewith, where the computer readable storage medium is not a transitory signal per se and where the computer readable program code when executed on a computer causes the computer to:
create, by machine-controlled web navigation and machine learning, each of:
(1) a composite knowledge base of service components, with each service component in the composite knowledge base defined by (i) features that are offered, and (ii) how the respective service component connects and exchanges data with other service components; and
(2) a composite service catalog comprising identified available implementations of the service components;
apply, by machine-based application of machine-learned knowledge created within the composite knowledge base and the composite service catalog, the service component definitions to a service solution under development to identify at least one service component usable to provide a technological improvement of the service solution under development; and
output a service technology improvement report that details the technological improvement of the service solution under development provided by the identified at least one service component.

15. The computer program product of claim 14, where the machine learning performed by the processor during the machine-controlled web navigation comprises machine-based natural language processing of content published by multiple different component vendor websites.

16. The computer program product of claim 14, where the machine learning performed by the processor during the machine-controlled web navigation comprises machine-based natural language processing of content postings published at social media websites by users of the social media websites related to each of user experiences with the service components and techniques related to the use and integration of the service components.

17. The computer program product of claim 14, where each service component in the composite knowledge base is further defined by best practices for use and integration of the respective service component into service solutions identified through machine-based natural language processing of content postings published at social media websites by users of the social media websites.

18. The computer program product of claim 14, where:
the identified available implementations of the service components comprise tool chain specifications that detail use and integration of the service components into other service solutions; and
in causing the computer to apply, by the machine-based application of the machine-learned knowledge created within the composite best practice knowledge base and the composite service catalog, the service component definitions to the service solution under development, the computer readable program code when executed on the computer causes the computer to perform a machine-controlled comparison of the tool chain specifications of the identified available implementations of the service components with a current tool chain implementation of the service solution under development.

19. The computer program product of claim 14, where the service technology improvement report further identifies integration details of the at least identified one service component, that provides the technological improvement of the service solution under development, into the service solution under development.

20. The computer program product of claim 14, where the machine learning and the machine-based application of machine-learned knowledge are provided as a service in a cloud computing environment.
